(19) United States
(12) Patent Application Publication
(10) Pub. No.: US 2007/0185725 A1
(43) Pub. Date: Aug. 9, 2007

(54) Process for the tracking of recording artist's, music publishers, and writer's revenues

(76) Inventors: Pamela Jean Taylor, Reseda, CA (US); Maria Amarillas, La Crescenta, CA (US)

Correspondence Address: Pamela Black, 7420 Corbin Ave. Unit 19, Reseda, CA, 91335, US

(21) Appl. No.: 11/350,134

(22) Filed: Feb. 7, 2006

(51) Int. Cl. G06Q 99/00

(52) U.S. Cl. 705/1

(57) ABSTRACT

A Software Process and Program that collects data from various income sources, including the calculation of the Units Sold into actual dollar amounts per Unit; streamlines that data according to the Artists' percentage of earnings as stated in their Recording Agreement, then it calculates and consolidates that revenue information on a secured Website for the Artist's select viewing and knowledge.

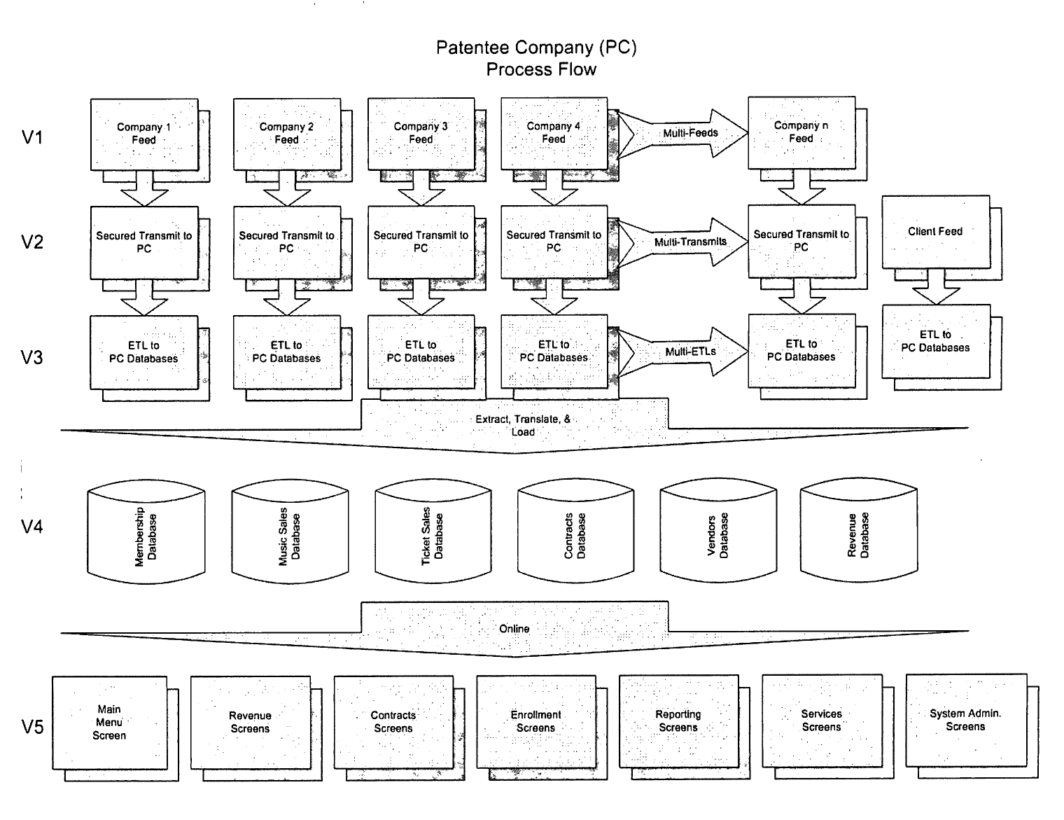

### STATEMENT REGARDING FEDERALLY SPONSORED RESEARCH OR DEVELOPMENT

N/A

### CROSS-REFERENCE TO RELATED APPLICATIONS

N/A

### REFERENCE TO SEQUENCE LISTING, A TABLE, OR A COMPUTER PROGRAM LISTING COMPAACT DISC APPENDIX

N/A

### BRIEF SUMMARY OF THE INVENTION

A system via the Internet by which Recording Artists', Publishers and Writers can gain access to accurate up-to-date detailed information of their expected revenues from the various income sources.

The Entertainment Industry currently lacks an adequate system in which to track Artists' revenues from all of their income sources which are mainly License Fee's, Record Sales, Concert Sales, Residuals and Royalties; and there is no system in place to provide accurate records of artist's earnings according to their contract's percentage (their share of sales). We have designed a system that will gather, consolidate, personalize and display this information.

### BRIEF DESCRIPTION OF THE SEVERAL VIEWS (V1-V5) OF THE PROCESS FLOW CHART

V1 Our Software gathers and consolidates revenue data methodically from multiple sources.

V2 The raw data is streamlined through our software program.

V3 Our program extracts, translates and loads expected revenues from music sales and related data.

V4 Databases are established to consolidate and house Artists' information.

V5 The Artists' screens/views/reports used to retrieve Artists' information.

### DETAILED DESCRIPTION OF THE INVENTION

Our Software gathers and consolidates revenue data methodically from multiple sources that are the Industry non-standard computerized systems for tracking music sales and associated revenues nationwide. This data is obtained/purchased from industry providers.

Multiple sources, including but not limited to, music sales, licensing fess, royalties, residuals, concert sales, etc, are accessed by our system to yield an in-depth and comprehensive summary of expected and generated revenues for the Artist's work. This data is obtained/purchased from industry gatherers/providers.

The raw data is streamlined through our software program providing the Artists' with the ability to instantly and in a secured manner access their global revenues from their various income sources, with further capability of computing expected revenues from music sales as per their negotiated artist contract/agreement. This provides the artist with a comprehensive yet simple and flexible system at their fingertips to manage and monitor their revenues more accurately.

What is claimed is:

1. A tracking system that captures the revenues of the Artist that is simple, effective, and user friendly.

2. A software program that provides each Artist with up-to-date, streamlined, accurate, and personalized information regarding their expected revenues from the main income sources for Artists.

3. An effective tool that provides an insight into the Artists' consolidated earnings and revenues.
